(19) United States
(12) Patent Application Publication
(10) Pub. No.: US 2006/0018012 A1
(43) Pub. Date: Jan. 26, 2006

(54) Apparatus and methods for focusing and collimating telescopes

(76) Inventors: John E. Smith, Mission Viejo, CA (US); Stephen M. Cutts, Rancho Santa Margarita, CA (US); Jaime R. Canedo, Irvine, CA (US); Brian G. Tingey, Fountain Valley, CA (US); Kenneth W. Baun, Trabuco Canyon, CA (US); Joop Kolster, Wildomar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/899,221

(22) Filed: Jul. 26, 2004

(51) Int. Cl. G02B 17/00

(52) U.S. Cl. 359/366; 359/859

(57) ABSTRACT

One preferred embodiment of the invention comprises a catadioptric telescope comprising a primary mirror, a secondary mirror, and a corrector. The primary mirror, secondary mirror, and corrector are disposed along an optical path. A tube assembly preferably houses the primary mirror and corrector. The secondary mirror is preferably centrally located within and connected to the corrector. One or more actuators are mechanically connected to the corrector (and the secondary mirror affixed to the corrector). The actuators are movable such that the corrector and secondary mirror may be moved with respect to the primary mirror. By manipulating the position and/or orientation of the secondary mirror, the telescope may be focused and/or collimated.

### BACKGROUND OF THE INVENTION

1. Field of the Invention

This application relates to focusing and collimation of telescopes such as for example Schmidt-Cassegrain telescopes and Maksutov-Cassegrain telescopes.

2. Description of the Related Art

Astronomy, and in particular, optical astronomy is increasingly popular, and advancements have been introduced in recent years to the instruments used for astronomical observation. High performance optical telescopes for the amateur and more advanced enthusiast may include, for example, diffraction limited optical systems offering high resolving power as well as CCD cameras for recording vivid images. Such telescopes may have accurate computer controlled drive systems for positioning the telescope using databases of deep-sky objects, stars, objects in our solar system and even earth satellites. With such sophisticated equipment to assist the astronomer, astronomy can be wonderfully enjoyable while the images obtained can be impressive and awestriking.

Proper focusing and collimation are important for quality imaging. Telescopes are designed to collect substantially collimated light from distant objects in the sky and to focus the light onto a focal plane. In a Cassegrain telescope, light is collected by a large primary mirror and reflected toward a secondary mirror, which reflects the beam of light to the focal plane. (The primary mirror may alternatively be referred to herein as the primary, while the secondary mirror may alternatively be referred to herein as the secondary as is customary in the art.) The curved primary and secondary mirrors focus the beam onto the focal plane where an ocular or camera may receive the light for viewing or recording an image. The optical system, comprising the primary longitudinally displaced along an optical axis a distance from the secondary mirror, has an effective focal length, which is determined in part by this longitudinal separation. The longitudinal distance separating the primary and secondary may be adjusted to alter the location where the images come to focus. Conventional telescopes are focused by translating the primary mirror such that a sharp image is formed at the desired image plane.

Proper orientation of the mirrors with respect to the optical axis and to each other are also important for quality imaging. Misalignment in the form of tilt of the primary or secondary may result in image distortion.

What is needed are methods and designs for effectively focusing and collimating telescopes.

### SUMMARY OF THE INVENTION

Various non-limiting embodiments described herein include but are not limited to telescopes and apparatus and methods for focusing and collimating telescopes. One embodiment of the invention, for example, comprises a catadioptric telescope. This catadioptric telescope includes a tube assembly having a front cell and a rear cell. This tube assembly comprises a hollow telescope tube with proximal and distal ends. The rear cell is at the proximal end of the telescope and the front cell is at the distal end of the telescope tube. A primary mirror is disposed in the rear cell of the tube assembly. A corrector cell is distal to the front cell of the tube assembly. The corrector cell houses a corrector plate. A secondary mirror is centrally located with respect to and affixed to the corrector plate in the corrector cell. At least one electrically driven actuator is mounted to the front cell and the corrector cell so as to mechanically connect the corrector cell to the front cell. The actuator is movable in a controllable manner such that the corrector cell may be moved with respect to the front cell of the tube assembly and the corrector plate and secondary mirror can be moved with respect to the primary mirror. Control electronics are electrically connect to the electrically driven actuator. The control electronics have an output that provides signals to the electrically driven actuator to control movement of the actuator.

Another embodiment of the invention comprises a method of focusing a catadioptric telescope comprising a primary mirror, a secondary mirror, and a corrector, wherein the secondary mirror is affixed to the corrector. The method comprises monitoring feedback indicative of image focus for the catadioptric telescope and manipulating the corrector with one or more actuators mechanically connected to the corrector based on the feedback indicative of the image focus. The secondary mirror moves with the corrector so as to improve the focus of the telescope.

Another embodiment of the invention comprises a method of collimating a catadioptric telescope comprising a primary mirror, a secondary mirror, and a substantially optically transmissive optical element, wherein the secondary mirror is affixed to the substantially optically transmissive optical element. The method comprises (i) monitoring feedback indicative of the state of collimation of the catadioptric telescope and (ii) manipulating the substantially optically transmissive optical element with at least one actuator mechanically connected to the substantially optically transmissive optical element based on the feedback indicative of the state of collimation. The secondary mirror moves with the substantially optically transmissive optical element so as to improve collimation of the telescope.

Another embodiment of the invention comprises a catadioptric telescope comprising a primary mirror, a substantially optically transmissive optical element, and a secondary mirror. The primary mirror and the substantially optically transmissive optical element are disposed along an optical path through which light entering the telescope may propagate. The secondary mirror is affixed to the substantially optically transmissive optical element. The optical path continues onto the secondary mirror from the primary mirror. The catadioptric telescope further comprises a supporting structure for supporting the primary mirror and substantially optically transmissive optical element and one or more actuators are movable such that the substantially optically transmissive optical element and secondary mirror affixed thereto may be moved with respect to the primary mirror. The actuators comprises an electro-mechanical driver having electrical inputs and a rotatable threaded shaft connected to the electro-mechanical driver. The electro-mechanical driver rotates the threaded shaft with application of electrical power to the electrical inputs. A threaded coupler is threadedly connected to the rotatable threaded shaft such that the threaded fastener moves in a longitudinal direction along the rotatable threaded shaft when the shaft rotates. At least a portion of the substantially optically transmissive optical element can be translated when the rotatable threaded shaft is rotated by the electro-mechanical driver.

Another embodiment of the invention comprises a catadioptric telescope comprising a primary mirror, a secondary mirror, and a tube assembly. The tube assembly comprises sidewalls that form a hollow inner region and has an optical aperture through which light enters the hollow central region. The catadioptric telescope further comprises at least one electrically driven actuator disposed at the sidewalls of the tube assembly and connected to the secondary mirror such that the secondary mirror may be moved with respect to the primary mirror. Control electronics having an output provide signals to the electrically driven actuator to control movement of the actuator.

Another embodiment of the invention comprises a catadioptric telescope comprising a primary mirror, a secondary mirror, and a tube assembly. The tube assembly comprises sidewalls that form a hollow inner region and has an optical aperture through which light enters the hollow central region. This optical aperture is no more than about 12 inches across. The catadioptric telescope further comprises at least one actuator disposed with respect to the secondary mirror such that the actuator may move the secondary mirror with respect to the primary mirror.

Another embodiment of the invention comprises a method of focusing a catadioptric telescope comprising a primary mirror, a secondary mirror, and a corrector wherein the secondary mirror is affixed to the corrector. In this method, positioning data is retrieved from a record. The positioning data relates to the position of the corrector. The corrector is manipulated with at least one electrically driving actuator mechanically connected to the corrector based on the retrieved positioning data. The secondary mirror moves with the corrector to alter focus.

Another embodiment of the invention comprises a catadioptric telescope comprising a telescope tube, a primary mirror, and a corrector. The corrector and the primary mirror are disposed along an optical path through the telescope tube. At least one connector connects the corrector to the telescope tube. The corrector is separated from the telescope tube by substantially thermally insulating regions. A secondary mirror is affixed to the corrector. The optical path continues to the secondary mirror from the primary mirror. A source of heat is disposed with respect to the corrector to heat the corrector. The substantially thermally insulating regions reduce thermal conduction of the heat from the corrector to the telescope tube.

### BRIEF DESCRIPTION OF THE DRAWINGS

FIG. 1 is a schematic cross-sectional view of a Schmidt-Cassegrain telescope comprising a primary spherical mirror, a secondary mirror, and a corrector plate rigidly affixed to the secondary mirror;

FIG. 2 is a schematic cross-sectional view of a Maksutov-Cassegrain telescope comprising a primary mirror, a secondary mirror, and a corrector plate wherein the secondary mirror comprises a reflecting surface formed on the corrector plate;

FIG. 3 is a perspective view of a catadioptric telescope comprising actuators for moving the corrector plate and secondary mirror for use in focusing and collimating the telescope;

FIG. 4 is a close-up perspective view of one of the actuators shown in FIG. 3.

FIG. 5 is a close-up top view of one of the actuators shown in FIG. 3.

FIG. 6 is a cross-sectional view along the line 6--6 of the actuator shown in FIG. 5 depicting the drive box assembly used to move the corrector plate and secondary mirror.

FIG. 7 is a front view of the corrector plate and actuators.

FIG. 8 is a cross-sectional view of the corrector plate and actuators taken along the line 8--8 in FIG. 7.

FIG. 9 is a block diagram schematically illustrating one embodiment of a control system comprising control electronics for controlling motion of the actuators.

FIG. 10 is a schematic drawing of a tube assembly including conduits for the motor, drive shaft, and drive box assembly for the actuators that manipulate the corrector plate and secondary mirror.

FIG. 11 is a schematic drawing of a telescope including a tripod and a fork assembly supporting a tube assembly and controller.

FIG. 12 is a schematic diagram of an image of a point source such as a star with a telescope that is sufficiently focused and collimated.

FIG. 13 is a schematic diagram of an image of a point source obtained with a telescope system that is out of focus.

FIG. 14 is a schematic diagram of a distorted image of a point source obtained with a telescope wherein the primary and secondary mirrors are misaligned.

### DETAILED DESCRIPTION OF THE PREFERRED EMBODIMENTS

FIG. 1 depicts a telescope 10 comprising a primary mirror 12, a secondary mirror 14, and focal plane 16. The telescope 10 further comprises a refracting corrector plate 18. The primary 12, secondary 14, and corrector 18 are aligned about an optical axis 20 centrally located through the telescope 10. This optical axis 20 is designated the z-axis in FIG. 1 and has orthogonal x- and y-axes. The primary mirror 12 may have, for example, a metallized parabolic reflecting surface 21, although the reflecting surface may have other shapes such as spherical or aspherical and should not be limited. The primary mirror 12 may comprise glass or Pyrex that is polished or shaped to form the curved reflecting surface 21. The secondary mirror 14 also has a curved reflecting surface 22. Like the primary 12, the secondary mirror 14 may also comprise glass and may be polished and metallized to form the curved reflecting surface 22. Other materials can be used for the primary and secondary mirrors 14, 18.

The refractive corrector plate 18 is preferably a substantially transmissive optical element comprising for example glass or other materials. The corrector plate 18 preferably has at least one, and possibly two shaped surfaces, which may be aspheric. The corrector plate 18, however, preferably has negligible optical power.

This telescope 10, having both reflective and refractive optical elements, is a catadioptric telescope. This particular configuration, which includes the combination of the primary and secondary mirrors 12, 14 and corrector plate 18, may be referred to as a Schmidt-Cassegrain. The curvature of the corrector plate 18 is different and distinct from that of the secondary mirror 14. Preferably, however, the secondary mirror 14 is rigidly affixed to the corrector plate 18 such that the two optical elements are connected together. FIG. 1 shows a baffle 24 between the corrector 18 and the secondary 14, however, preferably the corrector is attached to the secondary mirror through the baffle or other structure that secures the corrector and the secondary together.

In various preferred embodiments of the present invention, the secondary mirror 14 can be moved to focus and collimate the telescope 10. The secondary 14 can be translated longitudinally along the longitudinal (z-axis), toward or away from the primary 12 to focus. The secondary 14 preferably can also be tilted in different directions to collimate. For example, the secondary 14 may be tilted about the orthogonal x- or y-axes or other axes orthogonal to optical axis 20. The secondary 14 may be tilted about a center located on the optical axis (z-axis) or about off-axis centers as well. Other orientations for the secondary mirror 14 may be possible as well.

In preferred configurations where the secondary mirror 14 is affixed to the corrector plate 18, the corrector plate 18 may be translated or tilted to effectuate the desired longitudinal displacement or tilt of the secondary mirror 14. One or more actuators, for example, may be affixed to the corrector plate 18 to execute such movements. In various preferred embodiments, these actuators are at the perimeter of the corrector plate 18 and manipulate the corrector plate from its perimeter.

As shown, collimated rays from, for example, a celestial object, are received by the telescope 10. Preferably, the collimated rays pass through the corrector plate 18 without being substantially deviated such that movement of the corrector plate would interfere with quality imaging. In other embodiments discussed more fully below, the secondary may be affixed to a substantially optically transmissive plate such as an optical flat or window or is supported by a support structure such as vanes. Accordingly, the angle of the light may therefore not be altered by refraction. The collimated light propagates to the primary mirror 12 where the curved concave reflecting surface 21 converts the collimated beam into a converging beam directed toward the secondary mirror 14. The converging beam reflects off the convex curved reflecting surface 22 of the secondary mirror 14. The beam continues to converge toward the focal plane 16 where the beam is focused.

An image of the object is formed at this focal plane 16. Accordingly, an optoelectronic imaging device such as a CMOS or CCD camera can be disposed at, near, or with respect to the focal plane 16 to record an image of the object. Alternatively, an ocular can be positioned relative to the focal plane 16 to permit viewing of the image with the eye. In other configurations, optics or optical instruments, such as for example a spectrometer, can be suitably located with respect to the focal plane 16 to receive the light from the distant object.

The location where the image comes to focus is determined by the focal length of the telescope 10 and the location of the primary and secondary mirrors 12, 14. The focal length of the telescope 10 depends on the power of the primary and secondary mirrors 12, 14 and the longitudinal distance separating the primary from the secondary, which is shown in FIG. 1 as d₁. Longitudinally displacing the secondary mirror 14 in relation to the primary mirror 12, which increases or decreases d₁, therefore, shifts the focal plane of the telescope 10. Accordingly, by adjusting the separation of the primary and secondary mirror 12, 14, the focus of the image may be altered. Additionally, presuming that the focal length were held fixed, translation of the mirrors causes the focal plane, (shown in FIG. 1 to be distance d₂ from the secondary) to be displaced longitudinally as well. Accordingly, the secondary mirror 14 can be translated in a direction parallel to the longitudinal axis (z-axis) thereby shifting the location of the focal plane 16 with respect to, for example, a camera, ocular, or other optics. For these reasons, the telescope 10 can be focused by translating the secondary mirror 14 along the longitudinal axis.

The telescope 10 may also be collimated by moving the secondary 14 to improve the image quality. If the primary 12 and/or the secondary 14 are misaligned, e.g., tilted with respect to the optical axis 20, each other, or the focal plane 16, the image may be distorted. The telescope 10 is said to need collimation or alignment. The secondary mirror 14 may be tilted to correct this distortion. Accordingly, adjustment of the orientation of the secondary mirror 14 can therefore be adjusted to collimate the beam and enhance the clarity of the image.

FIG. 1 shows arrows 26, 28 schematically depicting possible movement of the corrector plate 18 and the secondary mirror 14, for example, in the longitudinal direction or tilting of the corrector plate and secondary mirror. In various preferred embodiments, the secondary mirror 14 is attached to the corrector 18 such that translation or canting of the corrector 18 displaces or reorients the secondary mirror in a similar manner. Accordingly, actuators configured to move the corrector plate 18 may, consequently, alter the position of the secondary 14 and thus focus the telescope 10 or change attitude of the secondary 14 and collimate the telescope.

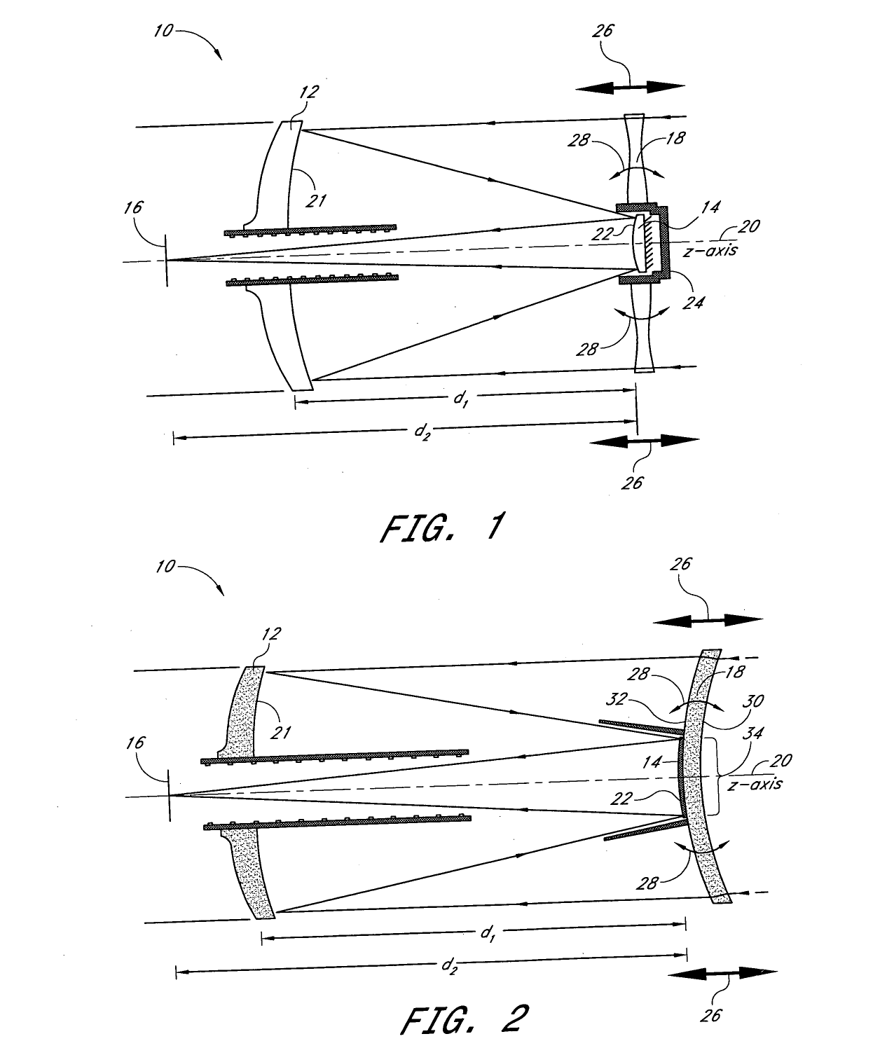

Another telescope design, known as a Maksutov-Cassegrain telescope, is shown in FIG. 2. In this catadioptric telescope 10, the secondary mirror 14 forms part of the corrector 18. In particular, the corrector 18 comprises a curved refractive optical element having forward and rearward surfaces 30, 32. The forward surface 30 is directed toward the object and the rearward surface 32 faces the primary 12. The corrector plate 18 depicted in FIG. 2 is substantially optically transmissive with the exception of a central region 34 thereof. The forward and rearward surface 30, 32 of the corrector 18 are concave transmissive surfaces to light propagating from a celestial object through the corrector 18 and to the primary mirror 12. In various preferred embodiments, the central portion 34 of the rearward surface 32 is metallized to form a substantially reflective surface corresponding to the secondary mirror 14. Other reflective coatings may also be employed as well. As a result of the shape of the corrector 18, the secondary mirror surface is convex. Also, since the secondary mirror 14 is formed on a surface 32 of the corrector lens 18, adjusting the position and orientation of the corrector such as for example schematically represented by arrows 26, 28 causes similar movement of the secondary reflector 14. Accordingly, the corrector 18 can be displaced longitudinally along the optical axis 20 to impart the desired translational motion to focus the telescope 10. Additionally, the corrector 18 can be tilted to introduce the desired amount of tilt in the secondary 14 to collimate the telescope 10. Focus and collimation of the telescope 10 can thus be accomplished by establishing the appropriate position and orientation, respectively, of the secondary mirror 14.

The specific optical designs and configurations of the telescope 10 should not be limited to those specifically described with reference to FIGS. 1 and 2. For example, the primary 12, secondary 14, and corrector 18 may have spherical or aspheric surfaces. These optical elements 12, 14, 18 may comprise glass, Pyrex, or other transmissive or non-transmissive materials. The reflective surfaces may be formed by metallization. Reflecting coatings of other types may be used as well. In different embodiments of the invention, reflective surfaces or structures may be otherwise created. The telescope 10 may include additional components such as baffles, stops, reflectors, lenses, polarizers, filters, holographic or diffractive optical elements and other optical elements. The telescope 10 may further comprise an ocular, a photographic or optoelectronic camera, optical instruments, as well as other subsystems, devices, and accessories.

In some preferred embodiments, the secondary 14 is connected to an optical element such as for example a substantially optically transmissive plate (e.g. glass plate or optical flat) instead of a corrector 18. Such an optical element may or may not have one or more curved surfaces and may or may not have optical power. The optical element, e.g., optical plate, lens, etc., may be moved in a manner discussed above to manipulate the position and orientation of the corrector 18. This optical element may be moved by one or more actuators 36 peripheral to the optical element. As with the corrector 18 plate, light would pass through the substantially optical element to the primary and secondary mirrors.

In other embodiments, the corrector 18 is replaced with a support structure such as one or more vanes secured to the secondary. The support structure may be moved by one or more actuators 36 to alter the position and/or orientation of the secondary mirror 14. These actuators 36 are preferably disposed in peripheral areas of the support structure so as to reduce obstruction of light that would otherwise propagate through the telescope 10 to the primary 12. Similarly, in the case where one or more vanes is employed to support the secondary mirror 14, the vanes are preferably substantially thin with respect to the aperture of the telescope 10 such that the vanes do not prevent a substantial portion that would otherwise reach the primary mirror 12. Alternatively, the vanes or supports may be substantially optically transmissive.

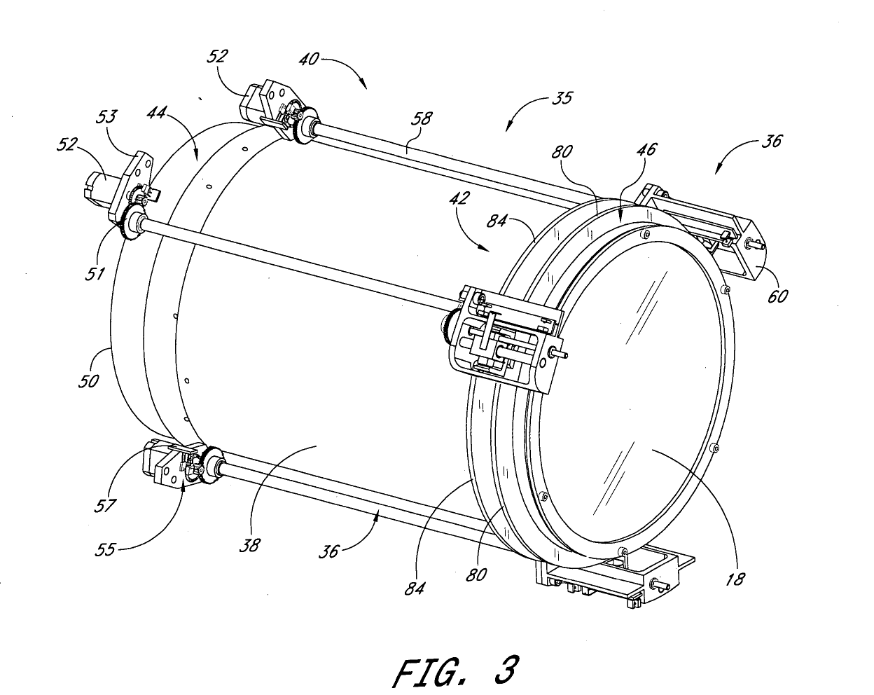

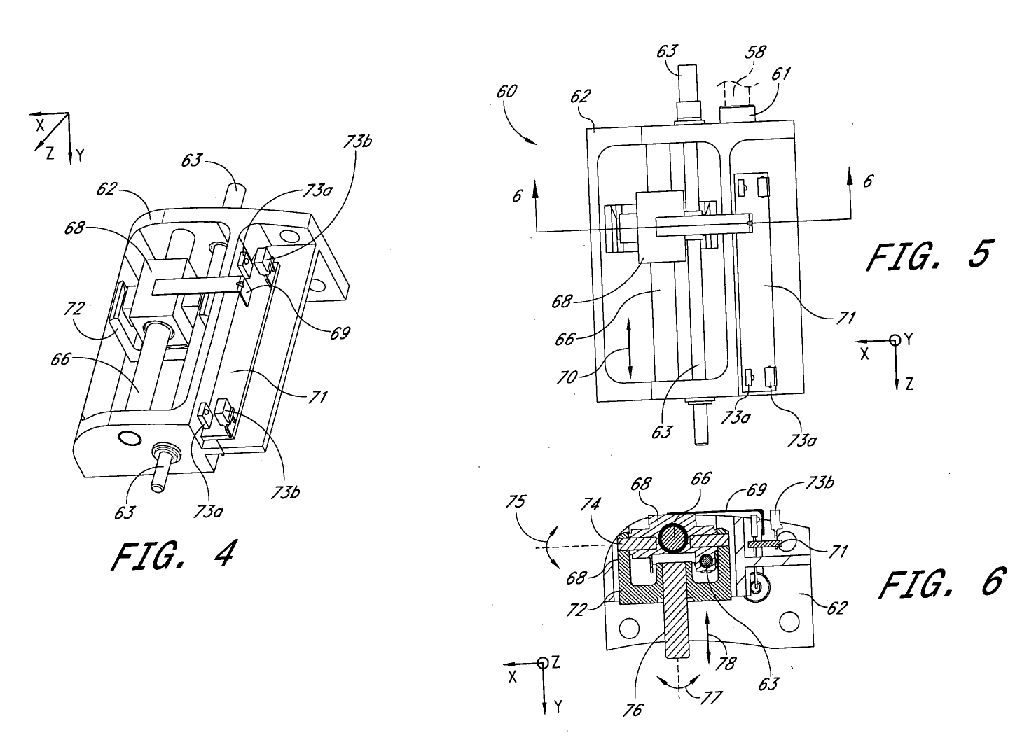

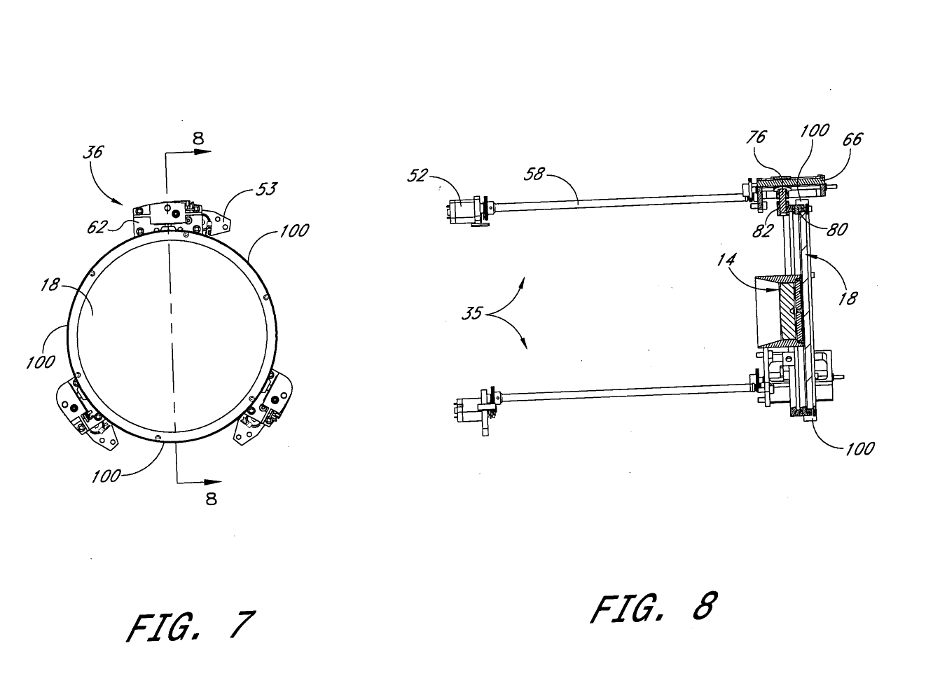

An embodiment of the telescope 10 comprising a focusing/collimation assembly 35, which comprises a plurality of actuators 36 for manipulating the corrector plate 18, is illustrated in FIG. 3. The telescope 10 shown in FIG. 3 includes three such actuators 36. Close-up perspective and top views of a portion of the actuators 36 is depicted in FIGS. 4 and 5. A cross-sectional view through one of the actuators 36 is presented in FIG. 6. A front view of the telescope 10 and a cross-section through the focussing/collimation assembly 35 and secondary mirror 14 and corrector plate 18 is shown in FIGS. 7 and 8.

As shown in FIG. 3, the telescope 10 comprises a tube 38 that forms part of a tube assembly 40 for housing the primary mirror 12, secondary mirror 14, and corrector 18. The tube 38 has a front (or distal end) and a rear (or proximal end) designated the front cell 42 and the rear cell 44. The distal end of the tube 38 may be directed toward a celestial object to be viewed.

A corrector cell 46 is forward of the front cell 42 and houses the corrector plate 18. A space may separate the corrector cell 46 from the front cell 42 of the tube 38 (not shown). This space may be covered by a flexible skirt (not shown) comprising for example rubber, cloth, plastic, synthetic fabric, or other material for blocking light and dust, etc., from entry into the tube assembly 40. The secondary mirror 14 (see FIG. 8) is located at the center of the corrector plate 18. The primary mirror 12 is disposed at the rear cell 44. The rearward portion of the tube assembly 40 is essentially closed-off by a cell back 50 affixed to the rear cell 44. Photographic and optoelectronic cameras as well as other components and accessories can be connected to this cell back 50 in various embodiments. Preferably, the primary mirror 12 is firmly secured in the rear cell 44 using for example cement, glue, epoxy, silicone couching or other material to adhered the primary mirror to the cell back 50. The primary 12 may otherwise be connected, for example, to the tube assembly 40 or other rigid framework that preferably serves as a platform for the telescope optics. Fasteners or other devices for fixing the primary mirror 12 in place may be used as well. Rigidly securing the primary mirror 12 in place reduces misalignment and shifts due, for example, to vibration that may be introduced during focusing or collimation. Preferably, the primary mirror 12 will not become inadvertently tipped, tilted, or displaced, and thereby misaligned. In other embodiments, the primary mirror 12 may have a position and orientation that is adjustable, however, the primary is preferably rigidly affixed in place in various preferred embodiments.

As shown in FIG. 7, three actuators 36 may be employed and these actuators 36 may be disposed about a circular perimeter of the telescope 10 centered about the optical axis 20 through the telescope. In various preferred embodiments, these actuators 36 are separated azimuthally by about 120° about the optical axis 20 although the positions and respective azimuthal angles separating the actuators may vary and should not be limited.

In the embodiments depicted in FIGS. 3-8, each of the actuators 36 includes an electrical motor 52 in the proximity of the rear cell 44 of the telescope tube 38. The motor 52 is shown mounted to a mounting bracket 53. Preferably, this mounting bracket 53 is mounted to the tube assembly 40 or the motor is otherwise secured in place. A rotatable shaft extends from the motor 52 and rotates when the motor is activated.

In these embodiments, the actuators 36 further comprises a drive shaft 58 and a drive box assembly 60. The drive shaft 58 has a proximal end connected to the rotating motor shaft via drive gears 51 such that rotation of the motor shaft induces corresponding rotation of the drive shaft. In these embodiments, the actuator 36 further comprises an encoder 55 to track rotation of the motor 52. Preferably, this encoder 55 outputs a precise measure of the angular position of the rotating motor shaft and the drive shaft 58. A position sensor board 57 preferably includes electronics that outputs electrical signals from the encoder 55 based on the position of the rotatable motor shaft and drive shaft 58. These electrical signals may be communicated to control electronics as discussed more fully below.

As shown in FIG. 5, the drive shaft 58 has a distal end connected to a drive shaft bushing 61 on the drive box assembly 60. FIG. 5 depicts this drive shaft 58 in phantom. The drive box assembly 60 comprises a frame 62 that supports a threaded drive screw 63 which is rotatable. The drive shaft bushing 61 is connected to the threaded drive screw 63 through drive gears such that rotation of the drive shaft 58 and consequent rotation of the drive shaft bushing 61 causes rotation of the drive screw 63. The drive box frame 62 supports a guide pin 66 that extends a substantially parallel to the drive screw 63. The guide pin 66 passes through a coupler 68, which rides on the guide pin. An opening through coupler 68, through which the guide pin 66 passes, permits movement of the coupler in a longitudinal direction along the guide pin. The coupler 68 further comprises a threaded opening through which the threaded drive screw 63 passes. Rotation of the threaded drive screw 63 causes the coupler 68 to be longitudinally translated along the guide pin 66 in a direction parallel to the guide pin and the threaded drive screw as indicated by arrows 70. This direction is parallel to the z-axis shown in FIGS. 4-6. The drive box assembly 60 may further include a position sensing device comprising a position indicator 69 and a limit sensor board 71 having a pair of emitters 73a and detectors 73b for position sensing. This position sensing device together with the encoder 55 may enable precise tracking of the movement introduced by the actuator 36.

The coupler 68 is pivotably connect to a swivel yoke 72 by a pair of nut pins 74 that fit into opening in the coupler. These nut pins 74 screw into the swivel yoke 72, extending through the swivel yoke to the coupler 68. The pair of nut pins 74 establish pivot points that permit the swivel yoke 72 to rotate with respect to the coupler 68. In particular, the swivel yoke 72 may rotate about an axis through the nut pins 74 parallel to the x-axis shown in FIGS. 4-6. This angular motion is schematically illustrated in FIG. 6 by arrows 75.

One end of a swivel pin 76 fits in a cylindrical opening in the swivel yoke 72. Another end of the swivel pin 76 fits into another cylindrical opening in a swivel pin block 82 (see FIG. 8). This swivel pin 76 preferably permits movement of the swivel yoke 72 about an axis through the swivel pin parallel to the y-axis shown in FIGS. 4-6. This angular motion is schematically illustrated in FIG. 6 by arrows 77. Accordingly, the swivel pin 76 and the swivel pin block 82 can rotate with respect to the swivel yoke 72. The swivel pin 76 also preferably can move in a longitudinal direction parallel to the y-axis in FIGS. 4-6 as well. This axial motion is indicated by arrows 78 in FIG. 6. The swivel pin 76 can therefore preferably move in inward and outward directions with respect the opening in the swivel pin block 82 in which the swivel pin fits. The swivel yolk 72 and the swivel pin block 82 may thus have increased or reduced separation therebetween. The swivel pin block 82 is molded to a corrector cell plate 80 shown in FIGS. 3 and 8 and is thereby firmly secured to the corrector cell 46 and the corrector optic 18. The actuator 36 is thus mechanically linked to the corrector cell 46, the corrector 18, and the secondary mirror 14.

The actuator 36 is also mechanically connected to the front cell 42 of the telescope 10. In this embodiment, the frame 62 of the drive box assembly 60 is mounted to a drive assembly mounting plate 84 (shown in FIG. 3) that is firmly secured to the telescope tube 38. In the embodiment shown, the drive assembly mounting plate 84 comprises a ring-shaped or annular plate having an inner diameter substantially matched to the telescope tube 38. The drive assembly mounting plate 84 may support each of the drive box assembly units 60 for the three actuators 36 and thus form a physical connection to all three actuators.

Accordingly, the actuator 36 can be activated to re-position the secondary mirror 14. The motor shaft may be rotated in a controlled manner based on signals applied to the motor 52. Rotation of the motor shaft causes similar rotation of the drive shaft 58 and the threaded drive screw 63. The coupler 68 through which the drive screw 63 is threadedly connected, is translated with respect to the drive screw and the drive box assembly 60 as a result of the rotating drive screw. Displacement of the coupler 68 causes the swivel yoke 72, the swivel pin 76, and the swivel pin block 82 to be shifted and tilted with respect to the drive screw 63 and drive box assembly frame 62. Likewise the portion of the corrector cell 46 attached to the swivel pin block 82 via the corrector cell plate 80 is shifted with respect the front cell 42. The front cell 42 is also connected to the drive box assembly 60 through the drive assembly mounting plate 84. Shifting of this portion of the corrector cell 46 and similarly the corrector plate 18 may cause the corrector plate and the secondary mirror 14 to be tilted with respect to the telescope tube 38 and the primary mirror 12.

Activation of any single one or any combination of the actuators 36 together may be used to shift and/or tilt or tip the secondary mirror 14 as desired. For example, translation of each of the actuators 36 by equal amounts may in certain circumstances cause longitudinal displacement of the corrector cell 46 and secondary mirror 14 parallel to the optical axis 20. Shifting the corrector cell plate 80 by different amounts at the different actuator locations may cause the secondary mirror 14 to be tilted or tipped and may or may not include longitudinal displacement of the secondary toward or away from the primary mirror 12.

Preferably the encoder 55 and the position sensing device in the drive box assembly units 60 permit the movement and position to be precisely monitored. Signals from the encoder 55 and position sensing device in the drive box 60 can be used to determine location and to thereby adjust the corrector 18 and secondary 14 in a controlled manner. Other types of position sensing and monitoring devices may be employed in other embodiments. In some embodiments, such position/movement sensors may be excluded.

Advantageously, the actuators 36 are configured to prevent binding and possible seizure. As the actuators 36 are used to tip and tilt the corrector cell 46, the orientation of the corrector cell may vary causing varyingly directed forces to be applied to the actuators. Preferably, the actuator 36 is designed to accommodate the movement of the corrector cell 46 and to avoid binding that may result from tension on the components of the actuator. For example, the pair of nut pins 74 permit swivel of the swivel yoke 72 with respect to the drive screw 63 and drive box assembly 60. This motion is represented by the arrow 75 in FIG. 6. Upon rotation of the drive screw 63 and consequent translation of the coupler 68, the angle of the swivel yoke 72 with respect to the swivel nut pins 74 and drive screw is thus free to change. In addition, the swivel yoke 72 may rotate about the swivel pin 76 and with respect to the swivel pin block 82. This angular motion is schematically represented by the arrow 77 in FIG. 6. Accordingly, if an adjacent actuator 36 is activated to tilt the corrector 18 and secondary mirror 14, the corrector cell 46 may tilt causing the swivel pin block 82 to rotate with respect to the swivel yoke 72. Binding and seizure can therefore be avoided when the corrector cell 46 is so tilted. The swivel yoke 72 may also be moved closer or farther from the swivel pin block 82 depending on the attitude of the corrector cell 46 with respect to the front cell 42 and the actuators 36. Advantageously, the swivel pin 76 fits into openings in the swivel yoke 72 and the swivel pin block 82 and is able to move longitudinally along a direction parallel to the pin's length. As a result, the swivel yoke 72 is able to move with respect to the swivel pin block 82. The longitudinal movement of the swivel yoke 72 with respect to the swivel pin block 82 is schematically represented by the arrow 78 in FIG. 6.

The actuators 36 depicted in FIGS. 3-6 represent various non-limiting embodiments of devices for manipulating the secondary mirror 14 and should not be construed as limiting. Other structures and designs may be used in other embodiments of the invention.

Although three actuators are shown in FIG. 3, more or less actuators may be employed. For example, one or more actuators may be used to focus the telescope 10. Two or more actuators may be used to collimate the telescope 10. Also, although a corrector 18 is shown, the secondary 14 may otherwise be supported by, e.g., an optical element such as a lens, an optical flat, or an optical plate that is not a corrector. One or more vanes or support beams or by other types of support structures may also be employed. The secondary 14 likewise may be manipulated by movements of these support structures. Preferably, the secondary 14 is manipulated by movement of actuators 36 disposed about the optical path where light propagates to the primary mirror 12 so as to reduce obstructions to light throughput to the primary mirror. For example, the telescope tube 38 may comprise sidewalls surrounding an inner region through which light passes to the primary 12. The actuators 36 may be disposed at these sidewalls. In various preferred embodiments, the actuators 36 are disposed outside these sidewalls such that the secondary mirror 14 is moved from beyond the inner region of the telescope 10 where light propagates to the primary 12 thereby reducing obstructions. Accordingly, the actuators 36 may be connected to the perimeter of the corrector 18 or other optical plate or at locations on the vanes or other support structures remote from the secondary 14. By placing the actuators 36 a distance from the secondary 14 and outside or at least less in the optical path of the light to the primary 12, more light may be collected by the primary.

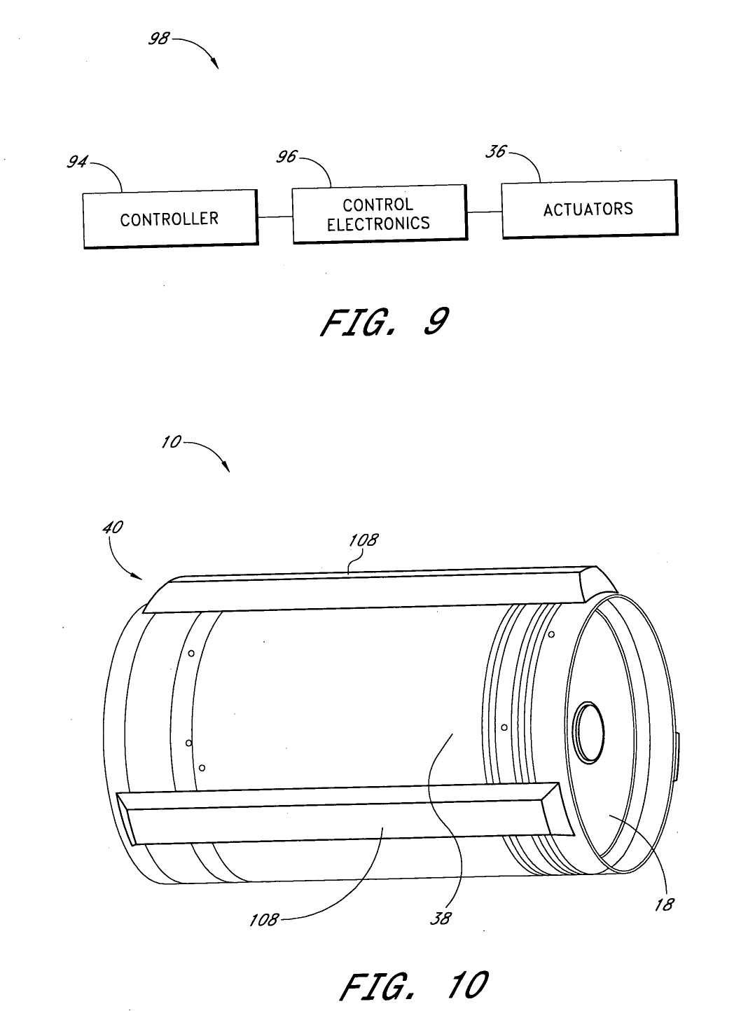

A controller 94 such as shown in a block diagram format in FIG. 9 may assist the user in focusing and collimating the telescope 10. In one preferred embodiment, the controller 94 is electrically connected to control electronics 96 as schematically illustrated in FIG. 9. The controller 94, the control electronics 96, and the actuators 36 may together form a control system 98 as shown by the block diagram. The controller 94 may act as the user interface through which a user issues instructions for manipulating and/or adjusting the telescope 10. The controller 94 may, for example, include a display for presenting information to the user and a keypad through which the user inputs instructions or data. For instance, to focus the telescope 10 the user can translate the corrector 18 and secondary mirror 14 toward or away from the primary mirror 12 by depressing these keys as will be discussed more fully below. The controller 94 may also include keys for specifying tilt or tip of the secondary 14 and corrector 18 to enable collimation. Although in some embodiments these keys may comprise buttons disposed on the controller 94, other touch sensitive surfaces may be employed as well. Various other configurations are also possible.

The control electronics 96 are preferably configured to receive signals output by the controller 94 and to drive the actuators 36 according to commands specified by the user. The control electronics 96 may comprise, for example, a computer or microprocessor or other electronics for processing signals from the controller 94. The control electronics 96 are preferably electrically connected to the actuators 36 and in particular to the motors 52 in the actuators. In one preferred embodiment, the control electronics 96 comprises digital electronics for sending control signals to the motors 52 in the actuators 36, which may comprise, e.g., D.C. servos, stepper motors, etc. In various preferred embodiments, the control electronics 96 comprise logic circuitry for converting instructions specified by the user with the controller 94 into the appropriate control signals for controlling the motors 52 and actuators 36 so as to fulfill the user's commands. For example, translating the secondary mirror 14, toward or away from the primary mirror 12 may involve movement of all three actuators 36 in the embodiment shown in FIG. 7. Tilting or tipping the secondary mirror 14 may comprise suitable movement of one of the actuators 36 or a combination of the actuators. Preferably, the control electronics 96 comprise the logic to determine the appropriate actuator 36 movement to effectuate the commands specified by the user. In a three point system such as shown in FIG. 7, for instance, the controller 96 preferably can cause the actuators to tip, tilt or translate the secondary 14 appropriately. For example, when focussing, the control electronics 96 preferably is capable of moving the actuators 36 in a suitable manner to introduce longitudinal displacement of the secondary mirror 14 while maintaining the secondary mirror properly centered and properly oriented. Additionally, when the secondary 14 is tipped and/or tilted during collimation, the secondary mirror also preferably remains focused. As discussed more fully below, the telescope assembly 40 may be reoriented (e.g., rotated and canted) to track the celestial object used to collimate and focus the telescope.

The control electronics 96 may also include logic to implement additional processes and features. For example, the process of focusing or collimating the telescope 10 may be automated. An image obtained by an opto-electronic camera such as a CCD or CMOS digital camera can be processed to determine whether the telescope 10 is focused or collimated and to determine suitable adjustments to the orientation and/or the position of the secondary mirror 14 to implement correction. Control signals based on these determinations may be sent to the actuators 36 to adjust the secondary mirror 14 accordingly. The control electronics 96 are also preferably configured so as not to permit the telescope 10 to bind, seize, or extend beyond the telescope's operating range. Other features may also be included. As described above, the actuators 36 may be outfitted with position sensors devices as well as encoders 55. These sensors may assist in limiting the movement to within a safe operating range.

The encoder 55 and position sensor devices in the actuators may additionally be employed to move the corrector 18 to a suitable or desired location. For example, pre-programmed focus positions may be stored for multiple users. Upon identifying the user, the telescope 10 may use, for example, the encoder 55 to set the particular longitudinal position of the secondary 14 for that user. The user may identify themselves by entering such information into the controller 94. In other embodiments, the telescope 10 may determine the user's identity by recognition of a user-identifying characteristic such as retinal pattern etc. Similarly, a database of objects with corresponding focuses may be stored and the actuators 36 may automatically adjust the focus of the telescope 10 depending on which object is being viewed. The user may indicate the object to be viewed. In certain embodiments, the telescope 10 will be equipped with ability to locate that object and may also include automated focusing as described herein. The encoder 55 or other positioning sensing and controlling systems can be employed to control the actuator 36 such that the secondary 14 is moved as desired. Alternatively, the user may specify a distance such as infinity or 30 feet and the controller 94 may process this request and determine the appropriate location of the secondary 14 to provide proper focus for such a distance.

In certain embodiments, the telescope 10 can ascertain relevant optical specifications of different components or accessories such as different oculars or photographic and optoelectronic cameras. For example, different devices that may be incorporated into the telescope system may have different focal lengths and thus alter the focusing characteristics of the telescope 10. This information can be employed by the controller 94 to suitably locate the secondary mirror 14 in the appropriate positions to provide an “in focus” image. Such information can be stored on the accessory, e.g., electronically, in certain embodiments.

The structure of the logic for various embodiments of the present invention as well as the logic for other designs may be embodied in computer program software. Moreover, those skilled in the art will appreciate that various structures of logic elements, such as computer program code elements or electronic logic circuits are illustrated herein. Manifestly, a variety of embodiments include a machine component that renders the logic elements in a form that instructs the actuators 36 or other apparatus to perform, e.g., a sequence of actions. The logic may be embodied by a computer program that is executed by the processor or electronics as a series of computer- or control element-executable instructions. These instructions or data usable to generate these instructions may reside, for example, in RAM, on a hard drive or optical drive, or on a disc. Alternatively, the instructions may be stored on magnetic tape, electronic read-only memory, or other appropriate data storage device or computer accessible medium that may or may not be dynamically changed or updated. Accordingly, these methods and processes including, but not limited to, those specifically recited herein may be included, for example, on magnetic discs, optical discs such as compact discs, optical disc drives or other storage devices or medium known in the art as well as those yet to be devised. The storage mediums may contain the processing steps which are implemented using hardware, for example, to control motion of the actuators 36, to focus or collimate the telescope 10, etc. These instructions may be in a format on the storage medium that is subsequently altered. For example, these instructions may be in a format that is data compressed.

The controller 94 and control electronics 96 depicted in FIG. 9 represent various non-limiting embodiments of the invention and the control of the actuators 36 can be implemented in other ways as well. For example, a user interface other than the controller 94 may be employed. The user interface may comprise, for example, computer, laptop, palm top, personal digital assistant, cellphone, or the like. Information may be displayed on a screen, monitor, or other display, and/or conveyed to the user via, e.g., audio or tactilely, as well as visually. A keyboard or keypad, or one or more buttons, switches, and sensors can be used to input information such as commands, data, specification, settings, etc. A mouse, joystick, or other interfaces can be used as well. User interfaces both well known in the art, as well as those yet to be devised may be employed to input and output information and commands.

In addition, some or all of the control electronics may be included in the controller 94 or user interface. For example, in the case where the user interface comprises a computer, laptop, palm top, personal digital assistant, cellphone, or the like, both the interface as well as some or all of the control and processing electronics may be included in the computer, laptop, palm top, personal digital assistant, cellphone, etc. Additionally, some or all the processing can be performed all on the same device, on one or more other devices that communicates with the device, or various other combinations. The processor may also be incorporated in a network and portions of the process may be performed by separate devices in the network. Processing electronics can be included elsewhere on or external to the telescope 10 and may be included for example in the actuators 36, as well as in or on the tube assembly 40 or elsewhere. The control electronics 96 may be in the form of processors, chips, circuitry, or other components or devices and may comprise non-electronic components as well. Other types of processing, electronic, optical, or other, can be employed using technology well known in the art as well as technology yet to be developed.

In addition, although motors 52 are shown as being used in the actuator 36, other transducers for repositioning or maneuvering the secondary mirror 14 are possible. Other types of motors 52 including, for example, stepper motors, as well as non-motor driven devices and systems such as, e.g., piezo-electric or electromotive devices, hydraulic or pressure driven systems, etc., may be utilized as well. The particular implementation should not be limited to those described herein as other types of devices and systems for manipulating the secondary mirror 14 may be employed and are within the scope of the present invention.

In various embodiments the actuators 36 may extend along the tube 38 as shown in FIG. 10. Electrical and/or mechanical apparatus may be covered by shrouds or conduits 108 on the telescope tube 38. For example, the motor 52, drive shaft 58, and drive box assembly 60 may be enclosed in a shroud. In various embodiments, the tube assembly 40 may be contoured to accommodate such conduits 108. As described above, the telescope tube 38 may comprise, for example, carbon fiber, which preferably reduces thermal drift effects. The conduits 108 may comprise, for example, carbon fiber, vacuum formed plastic or sheet metal. Other materials may be used as well. In other embodiments, conductive paths may be incorporated in the telescope tube 38. Signals other than electrical signals transmitted through conductive lines may be employed to control and/or communicate with the actuators 36. Optical, RF, or other types of signals may be propagated, for example, along waveguides such as optical fibers or may be unguided such as via wireless communication.

The controller 94 and control electronics 96 may be disposed on a tripod 110 below a rotating fork 112 holding the tube assembly 40 as depicted in FIG. 11. The actuators 36, motors 52, drive shafts 58, etc., are hidden from view in this embodiments. The controller 94 and/or control electronics 96 may be disposed elsewhere as well. In various embodiments, for example, control of the actuators 36 may be implemented via optical or RF signals or using other media to communicate with and/or deliver power to the actuators. As described above, the actuators 36 may be controlled by a computer such as a personal computer or a portable device such as a palm-held device or other device, network of devices, or system. Similarly, the control components and/or user interface can be located elsewhere and/or included in a variety of locations.

In addition, the actuator design need not be limited to the configurations described herein. Many variations are possible. For example, in different embodiments different parts that form the actuator 36 may be combined together. For instance, the swivel pin 76 and the swivel yoke 72 may be integrated into a single component or alternatively the swivel pin may be integrated together with the swivel pin block 82 to form a single structure. Similarly, the swivel pin block 82 separated from the corrector cell plate 80 or may be combined together. The drive box assembly frame 62 may possibly be integrated together with the drive assembly mounting plate 84 in some embodiments. In other preferred embodiments, however, these are separate components fastened together with suitable connectors or fasteners such as bolts and screws. Additionally, these components may be broken up into more or less component parts. Additional parts and features may also be added or components or design aspects may be removed. The design of the individual parts may be different or may be supplemented with additional components in other embodiments. Similarly, the connection between the components may be varied. For example, the connection between the actuator 36 and the secondary 18 may be different. For instance, the actuator 36 may be physically connected to the primary 12 through the drive assembly mounting plate 84 and the tube assembly 40 (including the telescope tube 38 and the rear cell 44) as well as other mounting components. In certain embodiments, the actuator 36 may be mechanically connected to the secondary 14 through the corrector plate 18 and any device used to connect these two optical elements as well as through the corrector cell 46 and the corrector cell plate 80. Alternatively, the actuators may be connected to the secondary 14 through support structures other than the corrector such as optical flats, vanes beams, etc., as discussed above. Additional components may be included to form mechanical connection between the actuator 36 and the primary 12 and between the actuator and the secondary 14. Alternatively, the physical connections may be formed otherwise, with less or more or different intervening components.

Other arrangements and designs may be employed including those based on conventional approaches to translation and positioning as well as translation and positioning concepts yet to be devised. Preferably, however, the actuators 36 are configured so as to prevent or reduce the likelihood of binding or seizure. Accordingly, three or more degrees of freedom may be provided. In other embodiments, however, more or less degrees of motion may be available with different designs. The actuators 36 may comprise metal components such as aluminum or stainless steel and may also include substantially temperature invariant materials such as Invar, which is substantially resistant to temperature induced changes. These components may be machined, molded, or otherwise manufactured. Also, although three actuators are shown, the number of actuators need not be limited to three. For example, one or two, or four or more actuators may be employed in different designs although three may be preferred. The location of the actuators 36 may also vary. Damping, shock absorption, vibration isolation, noise reduction or other features may also be included in various embodiments.

As described above, the user may actively focus and collimate the telescope 10 or a system may be included to automate the processes for focusing and collimation. In various embodiments, to focus, the telescope 10 is directed at the appropriate target object and is imaged. The image may be evaluated by measuring, e.g., the resolution, blur, or other figure of merit to determine whether the image is in focus. The actuators 36 may adjust the position of the corrector 18 and secondary 14 to improve the focus. Measurements of the image quality, blur, resolution, etc., can assist in such repositioning of the secondary 14, and corrector 18 until a suitably focused image is obtained.

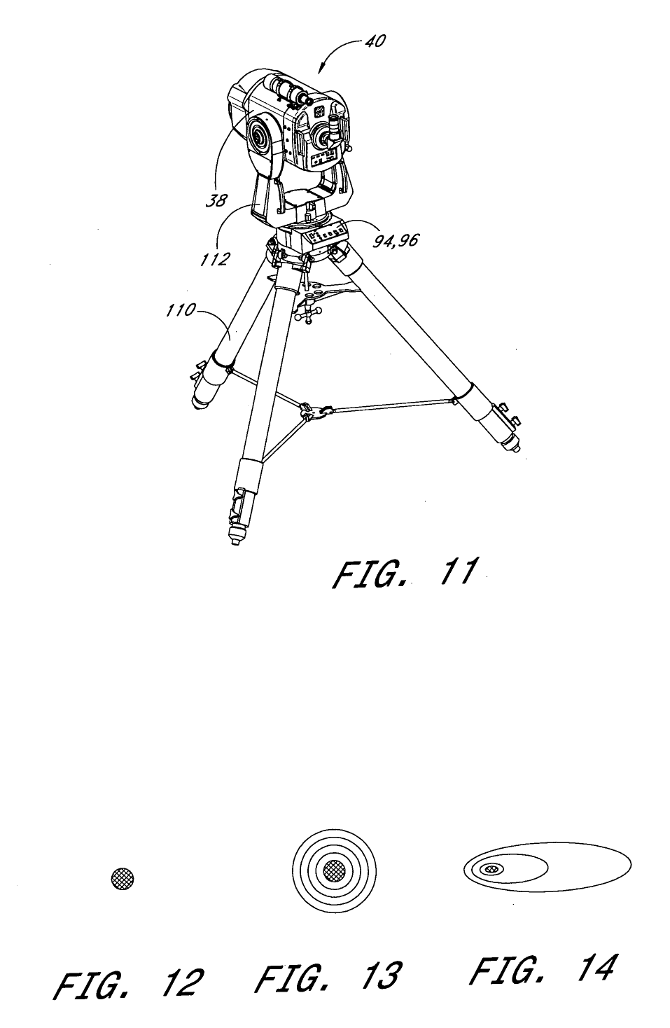

In the case where the telescope 10 is substantially focused and well collimated, an airy disc pattern preferably having substantially all optical energy in a central peak as schematically represented in FIG. 12, may be formed at the focal plane 16. In some cases, this airy disc may comprise a plurality of concentric circular and/or annular bright portions. A substantial portion of the light, however, is preferably distributed in a peak at the center of the circularly symmetric pattern. The intensity may oscillate with distance away from the center resulting in annular peaks or rings. However, superimposed on this oscillation is a general decrease in intensity with distance from the center, the rings farther from the center being less bright than those closer to the center. In some preferred embodiment, these rings are absent as described above. A telescope 10 yielding such a pattern may not require focusing or collimation or adjustment of the secondary mirror 14 as the telescope may already be sufficiently focused and collimated. A user therefore observing a pattern during the focusing or collimation process that is indicative of proper focusing and collimation, such as for example an airy disc pattern, may conclude that the telescope 10 is properly focussed and collimated. Similarly, if an automated system is employed, an airy disc pattern at the focal plane may be imaged by an optoelectronic detector or other image detection scheme. Image processing electronics 96 may assess the level of focus and collimation from the pattern obtained. This airy disc pattern may suggest to the processor that the level of focus and collimation is sufficient, and thus the control electronics 96 may refrain from introducing additional correction by manipulating the secondary mirror 14.

If, however, the primary and/or secondary mirrors 12, 14 are improperly focused or collimated, such deviations will preferably be indicated by features in the detected pattern. For example, if the primary and/or secondary mirrors 12, 14 are displaced from each other by too large or too small a longitudinal distance along the optical axis 20, the image may be out of focus. A pattern representing “defocus” is schematically illustrated in FIG. 13. As shown, more optical energy is shifted from the central peak and into the rings as compared to the image in FIG. 12. Similarly, the fall-off in brightness of the rings with increasing distance from center may be replaced with other irregular variations in the brightness of the rings. For example, one or more outer rings may be more intense than inner rings.

If the user observes a pattern indicating that the optical system is not properly focused, the user may adjust the longitudinal position of the secondary mirror 14 along the optical axis 20. In certain embodiments, for example, the user may use the controller 94 to translate the secondary 14 in the appropriate direction along the optical axis 20. As described above, this process may be automated in certain embodiments. The pattern obtained may be processed to determine whether the telescope 10 is sufficiently focused and possibly to quantify the amount of “defocus.” In certain embodiments, an intensity distribution may be obtained by a camera comprising, e.g., an optoelectronic camera. In the case where the telescope 10 is focused, the intensity pattern may correspond to a narrow peak. In contrast, defocus may be indicated by broader or wider peak as measured for example by full width half maximum. The control electronics 96 may direct the actuators 36 to translate the secondary mirror 14 to or away from the primary 12. The pattern can be monitored in some embodiments to determine when the level of focus is suitable. Other techniques can be employed as well to focus the telescope 10.

In various embodiments, to collimate the telescope 10 a distant point source is imaged and a pattern is produced on the focal plane 16 of the telescope. The primary and/or secondary mirror 12, 14 may be canted or angled in a manner that may introduce image degradation. Light from a distant point source focused on the focal plane 16 of the telescope 10 may produce a representative pattern on the focal plane such as schematically depicted in FIG. 14. Skewed alignment of the primary 12 and/or the secondary 14 may, for example, cause the pattern to be elongated. In comparison with the image in FIG. 12, for instance, the pattern shown in FIG. 14 is not circularly symmetric. Instead, the pattern in FIG. 14 comprises a central bright elliptical region and elliptical rings laterally offset from this central bright ellipse. The image may also be out of focus causing the intensity distribution to deviate from the more characteristic pattern associated with the airy disc. As described above, the airy disc pattern has a generally downward fall-off superimposed on intensity oscillations that results in a set of bright rings that reduce in intensity with distance from the center.

To improve or correct the collimation of the telescope 10, the secondary mirror 14 may be tipped or tilted appropriately. A user, for example, observing a pattern indicative of misalignment, such as schematically represented in FIG. 14, may, using the keys on the controller 94, activate the actuators 36 to achieve suitable correction. As described above, the control electronics 96 may receive signals from the user as to which direction correction is to be introduced. The control electronics 96 may determine from the user's instructions the appropriate actuator movements to implement the suitable adjustments to the secondary mirror 14. The user may monitor the pattern and may continue to indicate with the controller 94 the desired correction. The control electronics 96 may drive the actuators 36 accordingly. In this manner, improved collimation may result.

In other embodiments, the collimation process may be more automated. As described above, the pattern at the focal plane produced by the distant source may be processed to determine appropriate correction. In response to a pattern such as schematically represented in FIG. 14, for example, the control electronics 96 may determine how to manipulate the secondary mirror 14 to collimate the telescope 10. The control electronics 96 may send signals to the actuators 36 to move in an appropriate manner to provide suitable tilt or tipping. In the case where the image is also out of focus, the control electronics 96 may also direct the actuators 36 to include appropriate longitudinal translation components. The pattern may be monitored to ascertain whether collimation has been achieved or whether additional correction should be introduced.

In various embodiments, the telescope 10 may be moved in conjunction with movement of the secondary mirror to track the celestial object used for example, during collimation. Such an arrangement may avoid losing track of the celestial object which may potentially jump out of the field-of-view with adjustments to the secondary mirror 14 made in collimating the telescope 10. In such embodiments, for example, feedback from the actuators 36 or encoders or other components that monitor the position and movement of the secondary 14 and/or corrector 18 may be directed to control electronics that control positioning and tracking of the telescope 10. The electronics may be employed to determine the amount and direction of object shift and may automatically introduce proper movement and suitably reorient of the telescope 10. In various embodiments, for example, the control electronics may direct the rotating fork 112 to rotate and cant the telescope tube 38 to continue to maintain the celestial object in the field-of-view. Other configurations and approaches are possible.

Variations in the focusing and collimation processes may exist. Other techniques can be employed to determine whether the telescope 10 is focussed or collimated. Automation may or may not be applied to different extents and the automated systems or approaches may vary. Different types of processing may be performed as well to focus or collimate the telescope 10.

Also, one skilled in the art will appreciate that the drawing in FIGS. 12-14 are only schematic and are for illustrative purposes. A telescope 10 that is not focused and that is not properly collimated or that is misaligned may produce a pattern that includes other features as well. The actual patterns produced may vary in other ways also.

In certain embodiments, a heater 100 may heat the corrector 18 and/or secondary mirror 14. Such a heater 100, which may be useful for reducing condensation on the corrector 18 or other support structure such as optical flat or non-corrector optic, is shown in FIGS. 7 and 8. Preferably, the corrector cell 46 is largely separated from the telescope tube 38 and the remainder of the telescope tube assembly 40 by a substantially thermally insulating region, which reduces thermal conduction from the corrector cell 46 to the telescope tube and the remainder of the tube assembly. For example, in FIG. 7, the corrector cell 46 is connected to the telescope tube 38 and the reminder of the telescope tube assembly 40 via the three actuators 36. Three point connection is provided. The actuators 36 are located about a perimeter surrounding the tube assembly 40 and corrector cell 46. As shown in FIG. 7, these actuators 36 are spaced apart azimuthally about the corrector 18 by about 120° although other angles may be employed. The actuators 36 may be spaced at regular or irregular angular intervals and may be symmetrically or non-symmetrically disposed about the tube assembly 40. Preferably, a gap separates the corrector cell 46 from the front cell 42 in these regions between the actuators 36. This gap may be an air gap that permits tipping and tilting and other movement of the corrector 18 and secondary mirror 14 during, e.g., collimation. Alternatively, flexible and preferably thermally low conductive or insulating cover may be provided such that the corrector 18 may be tipped or tilted several degrees. Accordingly, the primary physical and thermal contact between the front cell 42 and the corrector cell 46 is through the actuator components such as the swivel yoke 72, swivel pin 76, and swivel pin block 82. In certain embodiments, a component such as a dust curtain or skirt may bridge the otherwise substantially open regions between the front cell 42 and the corrector cell 46. Preferably, however, this component is substantially thermally insulating and/or poor thermal-contact is made between this component and either the corrector cell 46 and/or other portions of the telescope 10. Accordingly, thermal energy is not readily conductively transferred through this component (e.g., skirt or curtain) from the heated corrector cell 46 to the front cell 42 or other portions of the telescope 10.

In embodiments not employing actuators 36, the corrector cell 46 may nevertheless be substantially separated from the remainder of the telescope tube assembly 40 and heated. The corrector cell 46 may be connected to the telescope tube 38 at a limited range of points. Preferably, a plurality of connectors connect the corrector 18 to the telescope tube 38. The plurality of connectors are preferably spaced apart around the corrector 18 and the corrector is separated from the telescope tube 38 by substantially thermally insulating regions between these spaced apart connectors. As described above, the actuators 36 may be spaced apart about the corrector 18 by intervals other than shown in FIG. 7. These connectors may or may not be evenly spaced about the corrector 18 and telescope tube 38 and more or less connectors may be employed.

Insulating regions may be disposed between the connectors. These regions may comprise air gaps or thermally insulating material or media in certain embodiments. The contact between the corrector cell 42 and the remainder of the telescope tube assembly 42 is thereby reduced. This configuration decreases the amount of thermal energy in the corrector cell 46 that is lost by thermal conduction to the remainder of the telescope 10. The heater 100 may therefore more efficiently heat the corrector 18 (or other support structure such as optical plate or optical element supporting the secondary 14) as the amount and size of the heat conduction paths to the remainder of the telescope 10 is substantially reduced.

This heater 100 preferably provides a source of heat for the corrector 18 and possibly secondary mirror 14. The heater 100 may comprise a heating element in thermal and physical contact with the corrector cell 46. This heating element may be in thermal and physical contact with the corrector 18 and may be secured thereto by a variety of techniques. In some embodiments, one or more substantially thermally conducting components may separate the heating element and the corrector. In various preferred embodiments, the heater 100 comprises a resistive heater such as a heat strip, heat tape, or other type of heating element. For example, a heat strip or heating tape may be applied to a perimeter of the corrector 18. Other methods of heating the corrector 18 (and/or possibly the secondary 14) may be employed as well.

As described above, air gaps or other thermally insulating regions preferably are disposed between the corrector 18 and/or secondary 14 and the telescope tube 36 or other portions of the tube assembly. These substantially thermally insulating regions may provide thermal insulation reducing thermal conduction from the corrector cell 46 to, for example, the front cell 42 or other portions of the telescope 10. A substantial portion of the thermal energy will therefore preferably remain in the corrector cell 46 thereby permitting the heater 100 to more efficiently heat the corrector plate 18. Less energy will therefore be required to heat the corrector 18 to abate the accumulation of condensation.

In certain preferred embodiments, where the corrector cell 46 is substantially thermally isolated from the front cell 42, connection between the front cell and the corrector cell is provided by the actuators 36 described above. In such cases where actuators 36 control the position of the corrector 18 and secondary 14, the controller 94 may adjust the position of the secondary to compensate for thermal shifts possibly due to thermal expansion resulting from heating the corrector and/or secondary. Other arrangements are also possible.

The various embodiments described herein may offer some useful advantages. Telescopes may be focused and collimated more conveniently and potentially more accurately. The user can focus and collimate the telescope 10 quicker, with less difficulty and possibly remotely. The process may also be automated in full or in part. By moving the telescope 10 in conjunction with adjustments to the secondary mirror 14, abrupt jumps in the pattern at the focal plane that is used to evaluate collimation in certain embodiments may be reduced or avoided altogether. Accordingly, a camera such as an optoelectronic detector may be used in the collimation process. Moving the secondary 14 at the perimeter of the telescope tube assembly may reduce obstruction of light reaching the primary and thus collected by the telescope. In many telescope designs, the secondary mirror 14 and corrector 18 together weigh less than the primary 12. Thus, moving the corrector 18 and secondary 14 together is easier than moving the primary 12. Movement of the corrector 18 preferably causes only negligible, if any, reduction in the image quality as the corrector does not bend the beam substantially. The primary 12 can also be rigidly fixed in place, for example, with cement, epoxy, glue, or silicon couching, etc. Fixing the primary reduces shift in the image formed in comparison to designs where the primary is not securely fixed in place but moves. Disadvantageous vibration of the primary 12 may therefore be reduced. In other embodiments, the primary 12, secondary, 14, or corrector 18 or other support structure for the secondary, or any combination thereof can be manipulated and controlled by one or more actuators 36.

While certain preferred embodiments of the invention have been described, these embodiments have been presented by way of example only, and are not intended to limit the scope of the present invention. Various modifications and applications may occur to those skilled in the art without departing from the true spirit and scope of the invention as defined in the appended claims.

What is claimed is:

1. A catadioptric telescope comprising:
a tube assembly having a front cell and a rear cell, said tube assembly comprising a hollow telescope tube with proximal and distal ends, said rear cell at said proximal end of said telescope and said front cell at said distal end of said telescope tube;
a primary mirror disposed in said rear cell of said tube assembly;
a corrector cell distal to said front cell of said tube assembly, said corrector cell housing a corrector plate;
a secondary mirror centrally located with respect to and affixed to said corrector plate in said corrector cell;
at least one electrically driven actuator mounted to said front cell and said corrector cell so as to mechanically connect said corrector cell to said front cell, said actuator movable in a controllable manner such that said corrector cell may be moved with respect to said front cell of said tube assembly and said corrector plate and secondary mirror can be moved with respect to said primary mirror; and
control electronics electrically connected to said electrically driven actuator, said control electronics having an output that provides signals to said electrically driven actuator to control movement of said actuator.

2. The catadioptric telescope of claim 1, wherein said primary mirror is rigidly affixed in said rear cell.

3. The catadioptric telescope of claim 2, wherein said primary mirror is fixed in place with silicone cauching.

4. The catadioptric telescope of claim 1, wherein said primary mirror is secured to an adjustable mount such that said primary mirror can be tilted.

5. The catadioptric telescope of claim 1, wherein said at least one electrically driven actuator comprises two actuators.

6. The catadioptric telescope of claim 1, wherein said at least one electrically driven actuator comprises three actuators spaced circumferentially around said corrector cell.

7. The catadioptric telescope of claim 1, wherein said actuator comprise a D.C. servo or stepper motor electrically connected to said control electronics.

8. The catadioptric telescope of claim 1, wherein said actuator is flexibly connected to said corrector cell so as to provide three degrees of freedom to accommodate tilting and tipping of said corrector plate without binding.

9. The catadioptric telescope of claim 1, wherein said actuator comprises a rotatable threaded shaft and a threaded coupler on said threaded shaft, such that rotation of said shaft translates said threaded coupler and displaces at least a portion of said corrector plate by a controlled amount with respect to said primary mirror.

10. The catadioptric telescope of claim 9, wherein said threaded coupler is connected to a mount on said corrector cell through a pin permitting rotation about an axis extending substantially radially from an optical axis through said primary and secondary mirrors.

11. The catadioptric telescope of claim 10, wherein said threaded coupler is connected to said mount on said corrector cell through a fixture that is pivotably connected to said threaded coupler such that said corrector can be tilted with respect to said rotatable threaded shaft in said actuator.

12. The catadioptric telescope of claim 1, wherein said tube assembly comprises shrouds to house said actuators.

13. A method of focusing a catadioptric telescope comprising a primary mirror, a secondary mirror, and a corrector, said secondary mirror being affixed to said corrector, said method comprising:
monitoring feedback indicative of image focus for said catadioptric telescope; and
manipulating said corrector with one or more actuators mechanically connected to said corrector based on said feedback indicative of said image focus, said secondary mirror moving with said corrector so as to improve the focus of said telescope.

14. The method of claim 13, further comprising transmitting electrical signals to electro-mechanical transducers in said actuators to control movement of said actuators.

15. The method of claim 13, further comprising moving said secondary mirror based on an image formed with light from a celestial object.

16. The method of claim 15, further comprising processing said image and manipulating said corrector based on data collected from said processing.

17. A method of collimating a catadioptric telescope comprising a primary mirror, a secondary mirror, and a substantially optically transmissive optical element, said secondary mirror being affixed to said substantially optically transmissive optical element, said method comprising:
monitoring feedback indicative of the state of collimation of said catadioptric telescope; and
manipulating said substantially optically transmissive optical element with at least one actuator mechanically connected to said substantially optically transmissive optical element based on said feedback indicative of the state of collimation, said secondary mirror moving with said substantially optically transmissive optical element so as to improve collimation of said telescope.

18. The method of claim 17, further comprising transmitting electrical signals to electro-mechanical transducers in said actuators to control movement of said actuators.

19. The method of claim 17, further comprising moving said secondary mirror based on an image formed with light from a celestial object.

20. The method of claim 19, further comprising processing said image and manipulating said substantially optically transmissive optical element based on data collected from said processing.

21. The method of claim 19, further comprising maintaining said telescope aimed at said celestial object by automatically repositioning said telescope.

22. A catadioptric telescope comprising:
a primary mirror;
a substantially transmissive optical element, said primary mirror and said substantially transmissive optical element disposed along an optical path along which light entering the telescope may propagate;
a secondary mirror affixed to said substantially transmissive optical element, said optical path continuing onto said secondary mirror from said primary mirror;
a supporting structure for supporting said primary mirror and substantially transmissive optical element; and
one or more actuators that are movable such that said substantially transmissive optical element and secondary mirror affixed thereto may be moved with respect to said primary mirror, said actuators comprising:
an electro-mechanical driver, said electro-mechanical driver having electrical inputs;
a rotatable threaded shaft connected to said electro-mechanical driver, said electro-mechanical driver rotating said threaded shaft with application of electrical power to said electrical inputs; and
a threaded coupler threadedly connected to said rotatable threaded shaft such that said threaded fastener moves in a longitudinal direction along said rotatable threaded shaft when said shaft rotates,
wherein at least a portion of said substantially transmissive optical element can be translated when said rotatable threaded shaft is rotated by said electro-mechanical driver.

23. The catadioptric telescope of claim 22, further comprising a swivel fixture between said threaded coupler and said substantially transmissive optical element, said swivel fixture pivotably connected to said threaded coupler such that said swivel fixture may pivot with respect to said shaft to accommodate tilt of said substantially transmissive optical element.

24. The catadioptric telescope of claim 23, wherein said swivel fixture comprises a swivel yoke.

25. The catadioptric telescope of claim 24, further comprising a mount secured in connection with said substantially transmissive optical element.

26. The catadioptric telescope of claim 25, further comprising a swivel pin that permits said mount secured in connection with said substantially transmissive optical element to swivel with respect to said swivel fixture so as to accommodate tilt of said substantially transmissive optical element.

27. The catadioptric telescope of claim 22, further comprising drive electronics for providing signals to said electro-mechanical driver to control said rotation of said drive shaft.

28. The catadioptric telescope of claim 27, further comprising a user interface for receiving commands from a user, said user interface in communication with said drive electronics.

29. The catadioptric telescope of claim 22, wherein said electro-mechanical drivers comprise motors.

30. A catadioptric telescope comprising:
a primary mirror;
a secondary mirror;
a tube assembly comprising sidewalls that form a hollow inner region and has an optical aperture through which light enters said hollow central region;
at least one electrically driven actuator disposed at said sidewall of said tube assembly and connected to said secondary mirror such that said secondary mirror may be moved with respect to said primary mirror; and
control electronics having an output that provides signals to said electrically driven actuator to control movement of said actuator.

31. The catadioptric telescope of claim 30, further comprising a corrector plate affixed to said secondary mirror, said corrector plate having a perimeter to which said at least one actuator is connected such that said secondary mirror may be moved by moving the perimeter of said corrector plate.

32. The catadioptric telescope of claim 31, wherein said primary mirror, said secondary mirror, and said corrector are configured to form a Schmidt-Cassegrain type telescope.

33. The catadioptric telescope of claim 31, wherein said primary mirror, said secondary mirror, and said corrector are configured to form a Maksutov-Cassegrain type telescope.

34. The catadioptric telescope of claim 30, further comprising a substantially optically transmissive optical element affixed to said secondary mirror through which said light passed to enter said hollow central region of said tube assembly, said substantially transmissive optical element having a perimeter to which said at least one actuator is connected such that said secondary mirror may be moved by said actuator.

35. The catadioptric telescope of claim 34, wherein said substantially optically transmissive optical element is selected from the group consisting of a lens and an optical flat.

36. The catadioptric telescope of claim 30, further comprising a support structure affixed to said secondary mirror substantial extending from said secondary mirror across a portion of said hollow inner region substantially to said sidewall of said tube assembly, said at least one actuator being connected to said support structure such that said secondary mirror may be moved by said actuator.

37. The catadioptric telescope of claim 36, wherein said support structure include one or more vanes.

38. The catadioptric telescope of claim 30, further comprising at least one position sensor in communication with said actuator to provide feedback to said control electronics to control said actuator.

39. The catadioptric telescope of claim 38, wherein said position sensor comprises an encoder.

40. The catadioptric telescope of claim 30, wherein said at least one electrically driven actuator comprises two electrically driven actuators disposed at azimuthal locations about said sidewalls.

41. The catadioptric telescope of claim 30, wherein said at least one electrically driven actuator comprises three electrically driven actuators disposed at azimuthal locations about said sidewalls.

42. A catadioptric telescope comprising:
a primary mirror;
a secondary mirror;
a tube assembly comprising sidewalls that form a hollow inner region and has an optical aperture through which light enters said hollow central region;
at least one actuator disposed with respect to said secondary mirror such that said actuator may move said secondary mirror with respect to said primary mirror,
wherein said optical aperture is no more than about 12 inches across.

43. The catadioptric telescope of claim 42, wherein said primary mirror has a diameter of no more than about 12 inches.

44. A method of focusing a catadioptric telescope comprising a primary mirror, a secondary mirror, and a corrector, said secondary mirror being affixed to said corrector, said method comprising:
retrieving positioning data from a record, said positioning data relating to the position of said corrector; and
manipulating said corrector with at least one electrically driving actuator mechanically connected to said corrector based on said retrieved positioning data, said secondary mirror moving with said corrector to alter focus.

45. The method of claim 44, wherein said positioning data is retrieved from a record stored on a storage device.

46. The method of claim 44, wherein said positioning data is retrieved from a record provided by a controller upon indication of instructions regarding a desired object distance.

47. The method of claim 44, wherein said positioning data is retrieved from a record provided by a controller based upon a particular user's vision.

48. The method of claim 44, further comprising recording said record.

49. The method of claim 44, further providing positioning data as feedback to said actuators.

50. A catadioptric telescope comprising:
a telescope tube;
a primary mirror;
a corrector, said corrector and said primary mirror disposed along an optical path through said telescope tube;
at least one connector connecting said corrector to said telescope tube such that said corrector is separated from said telescope tube by substantially thermally insulating regions;
a secondary mirror affixed to said corrector, said optical path continuing to said secondary mirror from said primary mirror; and
a source of heat disposed with respect to said corrector to heat said corrector, said substantially thermally insulating regions reducing thermal conduction of said heat from said corrector to said telescope tube.

51. The catadioptric telescope of claim 50, wherein said substantially thermally insulating regions between said spaced apart connectors comprise air gaps.

52. The catadioptric telescope of claim 50, wherein said gaps are sufficiently large to permit tilting and tipping of said corrector and secondary mirror to enable collimation of said telescope.

53. The catadioptric telescope of claim 50, wherein said plurality of connectors comprise three connectors providing three-point connection.

54. The catadioptric telescope of claim 50, wherein said connectors are disposed at azimuthal locations about the perimeter of said corrector.

55. The catadioptric telescope of claim 50, wherein said connectors comprise actuators for moving said corrector with respect to said telescope tube.

56. The catadioptric telescope of claim 50, wherein said source of heat is in thermal contact with said corrector.

57. The catadioptric telescope of claim 50, wherein said thermally insulating regions separate said source of heat from said telescope tube.

58. The catadioptric telescope of claim 50, wherein said source of heat comprises a heating element physically secured to said corrector.

59. The catadioptric telescope of claim 50, wherein said source of heat comprises a heat strip disposed about a perimeter of said corrector.
